(19) United States
(12) Patent Application Publication
(10) Pub. No.: US 2024/0240640 A1
(43) Pub. Date: Jul. 18, 2024

(54) PARTS WASHER PUMP FOR USE WITH HEATED WATER BASED CLEANING FLUIDS

(71) Applicants: Ronald Bluestone, Lake Havasu City, AZ (US); Ryan Bluestone, Lake Havasu City, AZ (US)

(72) Inventors: Ronald Bluestone, Lake Havasu City, AZ (US); Ryan Bluestone, Lake Havasu City, AZ (US)

(21) Appl. No.: 18/410,923

(22) Filed: Jan. 11, 2024

Related U.S. Application Data
(60) Provisional application No. 63/438,716, filed on Jan. 12, 2023.

(51) Int. Cl. F04D 13/08; B08B 3/02; B08B 3/08; B08B 3/10; F04D 29/58; F04D 29/70

(52) U.S. Cl. CPC F04D 13/08; B08B 3/02; B08B 3/08; F04D 29/5806; F04D 29/708; B08B 3/10

(57) ABSTRACT

A parts washer pump for use with heated water based cleaning fluids. A parts washer pump for use with heated water based cleaning fluids has a fan cooled electric motor coupled to a shaft at one end, and a submersible impeller pump coupled to the shaft at the other end. The pump may be submerged in a heated cleaning solution and the motor is kept at a distance and out of the cleaning solution.

### TECHNICAL FIELD

This description relates generally to parts washing systems and more specifically to parts washing systems using heated aqueous solvents.

### BACKGROUND

Parts washers are often used in machine shops, manufacturing, automotive transmission and engine repair shops. Also used in cleaning are soak tanks. Soak tanks are vessels containing a solvent such as a mixture of water and detergent, which take hours to “soften” the built-up road grime, fluids, tars and oils enough to be manually rinsed off prior to disassembly and repair. Heating the solution, and brushing can aid in loosening dirt and grime.

Gasoline, diesel fuel, and kerosene were commonly used to clean and degrease parts. Later, chlorinated solvents used in vapor degreasers were common. Environmental concerns led to the banning of chlorinated solvents for parts cleaning, which lead back to aqueous-based cleaning systems, but with improvements. A newer development is to utilize heated, aqueous based cleaning solutions. Hydraulic sprays may be used to improve the cleaning of parts by directing a pressurized solvent stream at a part from nozzles. Forcing a solution through a nozzle typically calls for the use of a pump in close proximity to the heated solution. However, contact with heated aqueous based solvents tends to cause such pumps to wear out somewhat quickly. Also it is difficult to cool a pump motor immersed in a heated solution.

Accordingly it would be desirable to have a pump for use in parts washing systems that is configured so that its parts are not exposed to the heated cleaning solution, is easy to cool, is cost effective, and tends to have a long life.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A parts washer pump for use with heated (or unheated) water based cleaning fluids and other types of cleaning solutions has an air fan cooled electric motor coupled to a shaft at one end, and a submersible impeller pump coupled to the shaft at the other end. The pump may be submerged in a heated cleaning solution and the motor is kept at a distance and out of the cleaning solution where air may be used to cool the motor and prolong its life.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a block diagram of a parts washer pump for use with heated water based cleaning fluids;

FIG. 2 is a parts washing system using a parts washer pump for use with heated water based cleaning fluids;

FIG. 3 is a downward looking inclined view of a parts washer pump for use with heated water based cleaning fluids;

FIG. 4 is a upward looking inclined view of a parts washer pump for use with heated water based cleaning fluids;

FIG. 5 is a front view of a parts washer pump for use with heated water based cleaning fluids;

FIG. 6 is a right side view a parts washer pump for use with heated water based cleaning fluids;

FIG. 7 rear view of a parts washer pump for use with heated water based cleaning fluids;

FIG. 8 left side view of a parts washer pump for use with heated water based cleaning fluids;

FIG. 9 is a top view of a parts washer pump for use with heated water based cleaning fluids; and

FIG. 10 is a bottom view of a parts washer pump for use with heated water based cleaning fluids.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a parts washer pump for use with heated water based cleaning fluids. Although the present examples are described and illustrated herein as being implemented in a parts washing system for heated water based cleaning fluids, the system described is provided as an example and not a limitation. As those skilled in the art will appreciate, the present examples are suitable for application in a variety of different types of cleaning systems, including heated and unheated, aqueous, petroleum based and the like.

A parts washer is a piece of equipment used to remove contaminants or debris, such as dirt, grime, carbon, oil, grease, metal chips, cutting fluids, mold release agents, ink, paint, corrosion from work pieces and the like. Parts washers are used in some of the last steps in the parts manufacturing process. Parts washers are designed to clean, degrease and dry small or large parts in preparation for the next manufacturing step, such as surface treatment, or packaging and shipping. Parts washers may also be used in reconditioning used parts and in repair shops. Parts washers are essential in maintenance, repair and remanufacturing operations as well, from cleaning fasteners, nuts, bolts and screws to engine parts and automotive assemblies.

Newly machined, molded and fabricated products are typically contaminated with oils, chemicals, burrs, abrasive dust, paint and other residue left over from the fabrication process of metal, plastic and rubber components. Applied coatings are not effective if they are applied on a dirty surface.

Most parts washers use a pump to create a spray of solvent or cleaner. The invention described herein uniquely provides an air cooled motor with a submersible pump coupled by a shaft long enough to keep the motor out of the parts cleaner. In addition the parts washing system described below may advantageously be used in small scale operations where fractional horsepower units capable of being used in conjunction with a barrel or drum tend to be absent in the market.

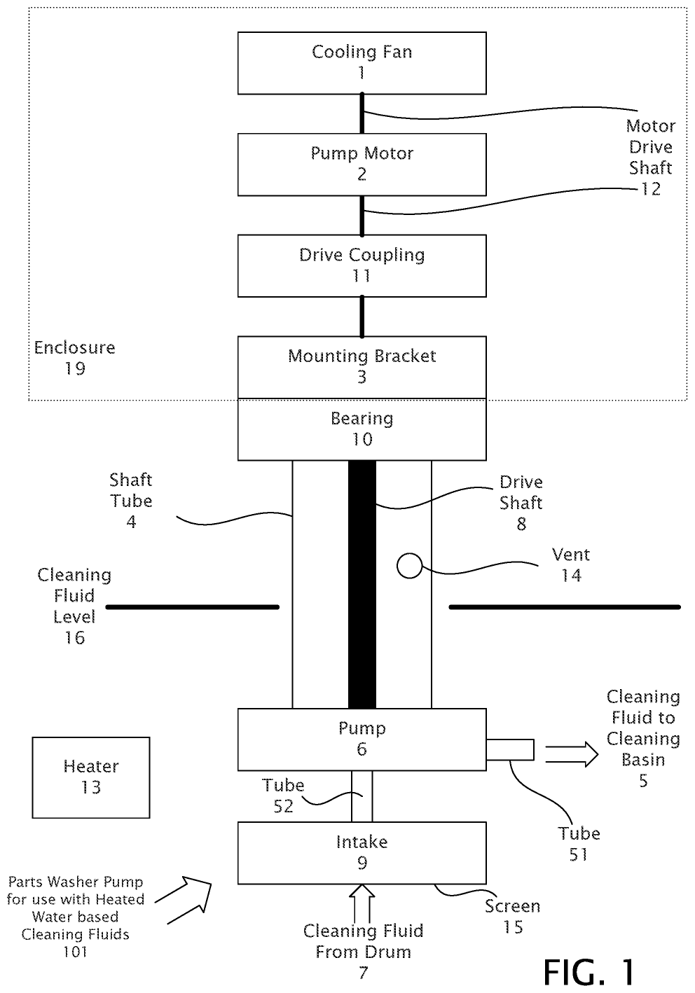

FIG. 1 shows a block diagram of a parts washer pump for use with heated water based cleaning fluids 101. In a typical submersible pump (not shown) all of the pump components are typically submerged in the liquid being pumped. However, such an arrangement exposes all of the pump components to the solution being pumped, which in the case of cleaning fluids and solvents tends to prematurely age the pump. To reduce pump wear and promote cooling in the parts washer pump for use with heated water based cleaning fluids 101 the motor 2 is mounted at a distance from the pump 6, with the pump 6 in the solution, and the motor 2 out of the solution above the cleaning fluid level 16 where it can be air cooled. This allows for optimal operation of the impeller pump 6 and improved cooling of the motor 2 as an additional cooling fan 1 may be included to cool the motor 2.

Pump motor 2 may include a shaft axially protruding through the motor. A first end of the motor shaft is coupled to a cooling fan 1. A second end of the motor shaft may be coupled through a drive coupling 1 land passing through a mounting plate 3 to couple to a drive shaft 8. At a first drive shaft 8 end adjacent to the drive coupling 11 the drive shaft 8 may be supported by a bearing 10. The drive shaft 8 is surrounded by a vented 14 shaft tube 4. At a second drive shaft end the drive shaft 8 is coupled to a pump 6, submersed below the cleaning fluid level 16. The pump 6 is coupled to an intake 9 with a screen 15 via a tube 52. Fluid from the drum 7 enters the intake 9 and is expelled from the pump 6 through tube 51 to a convenient location such as a cleaning basin 5. The vented shaft tube 4 protects the shaft 8 and provides mechanical support as an upper end of the shaft tube 4 is attached to a housing containing the bearing on the mounting plate or bracket. The lower end of the shaft tube is attached to the pump 6. A conventionally constructed immersion heater may be provided to heat the cleaning solution. It may be included in the parts washer pump for use with heated water based cleaning fluids assembly, or as a separate unit.

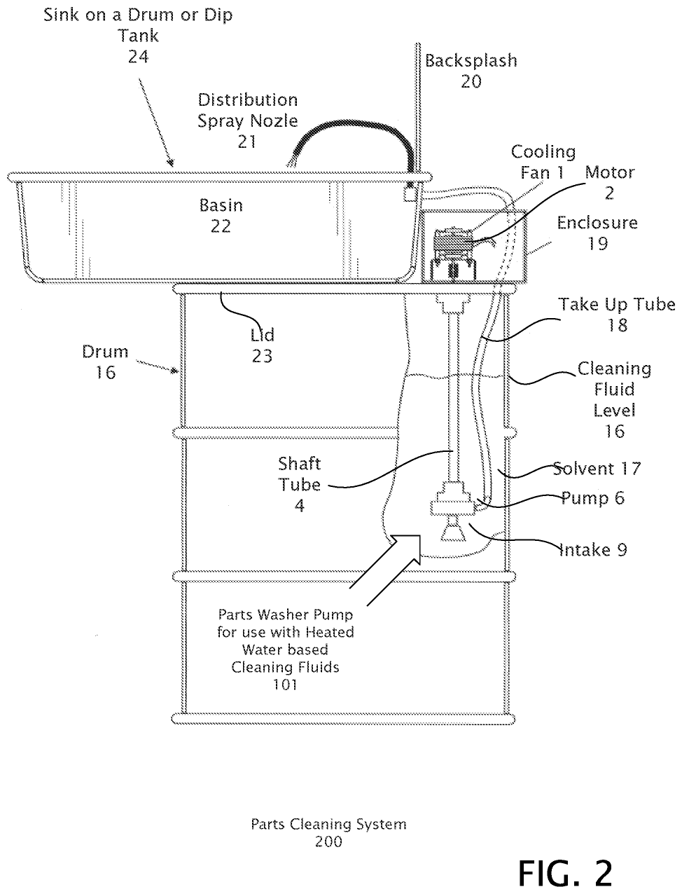

FIG. 2 shows a parts cleaning system 200 utilizing a parts washer pump for use with heated water based cleaning fluids 101. The system described may also be advantageously used with unheated solvents of various types that are available. As can be seen the submersed pump 6 is mounted away from the motor 2 that sits on top of the drum 16 lid 23. A suitable motor for this application is typically a fractional horsepower unit. With the pump 6 submersed in the cleaning solution 17, and the motor 2 above the fluid on top of a drum 16 or container a fan can be used to cool the motor 2. To protect the fan and motor the parts washer pump for use with heated water based cleaning fluids may be mounted in an enclosure 19 that may be attached, or resting on the lid 23 of a drum 16 containing the solvent 17. Alternatively the pump 101 may be attached to a basin 22 in which parts are washed with a distribution spray nozzle 21, which may incorporate a brush. To further protect the pump 101 a backsplash 20 may be installed between the basin 22 and the pump 101.

In operation solvent 17 enters the intake 9 where the pump 6 ejects it to a take up tube 18 and ultimately to a spray nozzle 21 discharging in a basin 22. In alternative examples the spray nozzle may include a cleaning brush, to aid in scrubbing parts. The motor 2 is further protected by an enclosure 19 that may be of any suitable material to shield the motor, preferably with air vents to aid operation of the fan 1.

The drum 16 may be any suitable basin or container suitable for holding the unused solvent 17. Likewise the basin 22 may be any suitable vessel for collecting spray from the conventionally constructed nozzle 21 when cleaning or washing parts. The backsplash 20 may be of plastic, wood or the like and may be integral to the basin 22 or an attached separate piece. Likewise the pump 101 may be separate from the basin 22 or it may be attached via either the housing or the mounting plate. In this particular application fractional horsepower motors tend to produce sufficient pressure at the nozzle.

In alternative examples a plurality of pumps 101 may be provided to increase pressure or to drive a plurality of spray nozzles.

The shaft tube 4 may be of adjustable length, or may be made of a length sufficient to reach near the bottom of the drum 16. Typically a screen or filter (not shown) is provided on the intake 9 to keep dirt and debris from the recirculating used solvent from entering the pump.

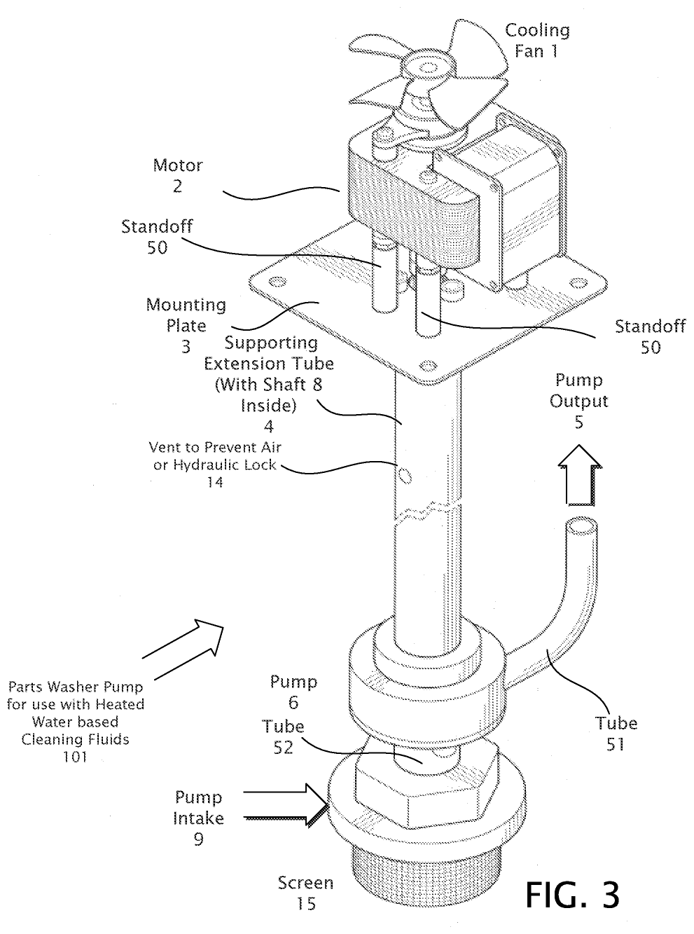

FIGS. 3-10 show various views of a parts washer pump for use with heated water based cleaning fluids. The following description relates to FIGS. 3-10.

FIG. 3 is a downward looking inclined view of a parts washer pump for use with heated water based cleaning fluids.

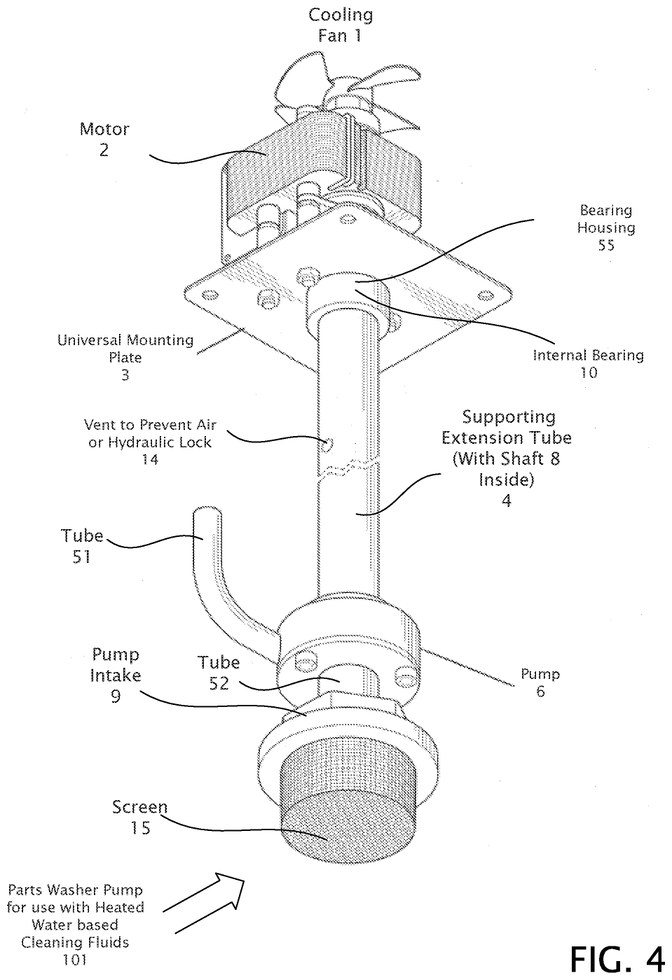

FIG. 4 is a upward looking inclined view of a parts washer pump for use with heated water based cleaning fluids.

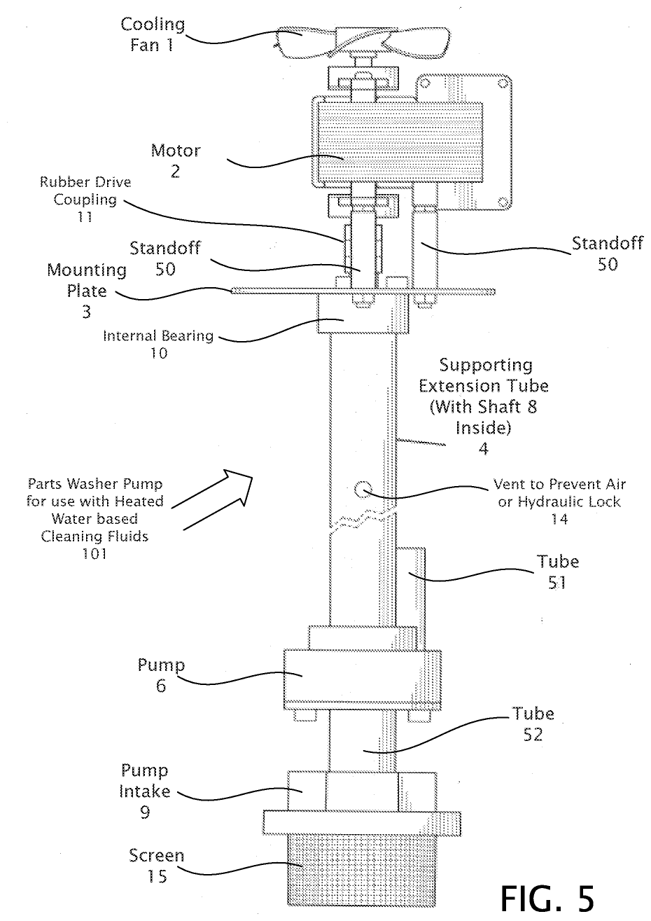

FIG. 5 is a front view of a parts washer pump for use with heated water based cleaning fluids.

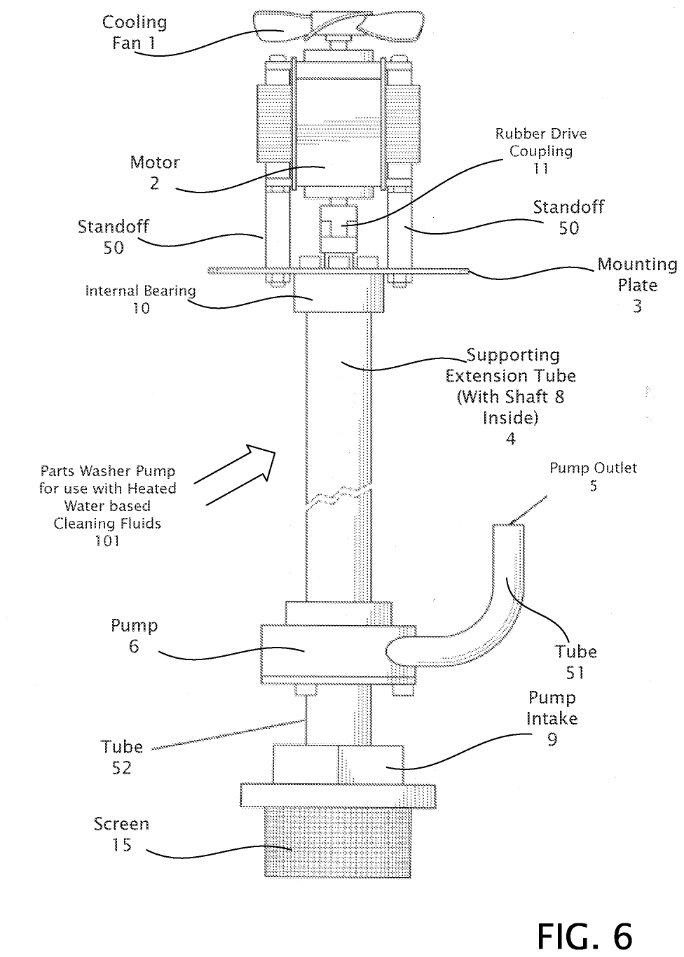

FIG. 6 is a right side view a parts washer pump for use with heated water based cleaning fluids.

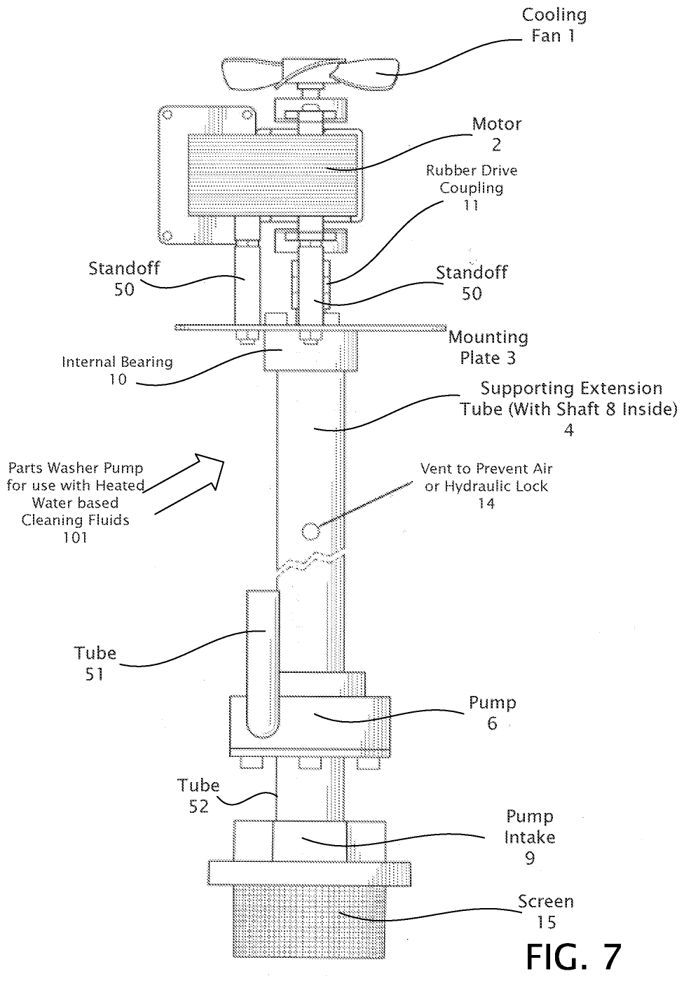

FIG. 7 rear view of a parts washer pump for use with heated water based cleaning fluids.

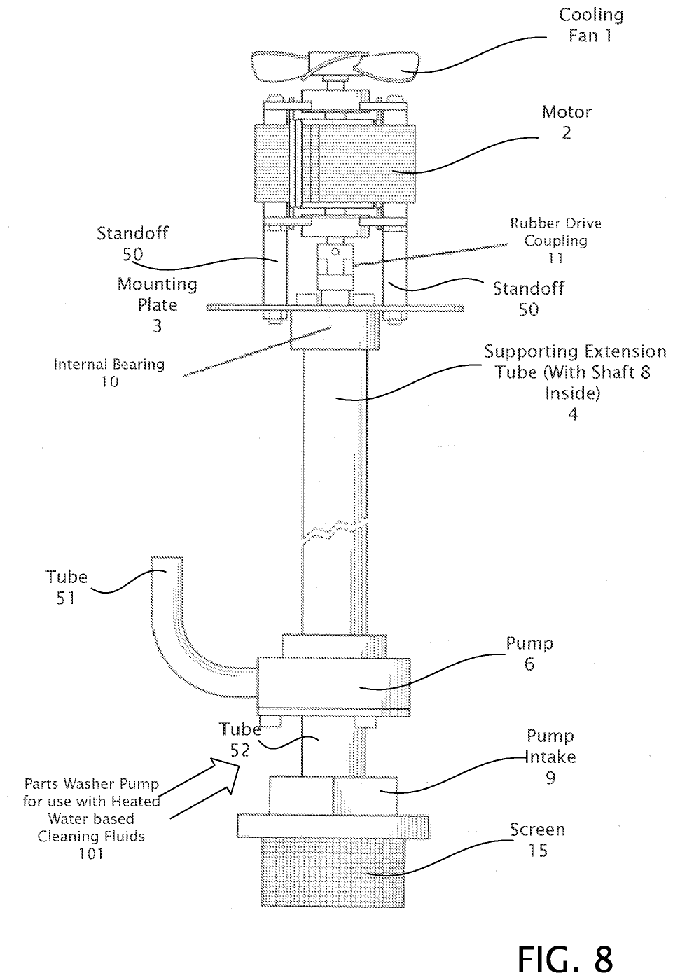

FIG. 8 left side view of a parts washer pump for use with heated water based cleaning fluids.

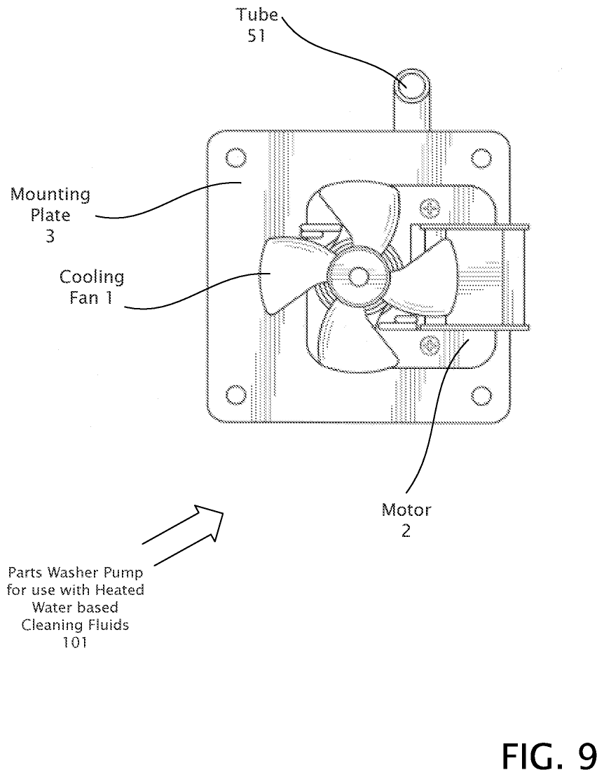

FIG. 9 is a top view of a parts washer pump for use with heated water based cleaning fluids.

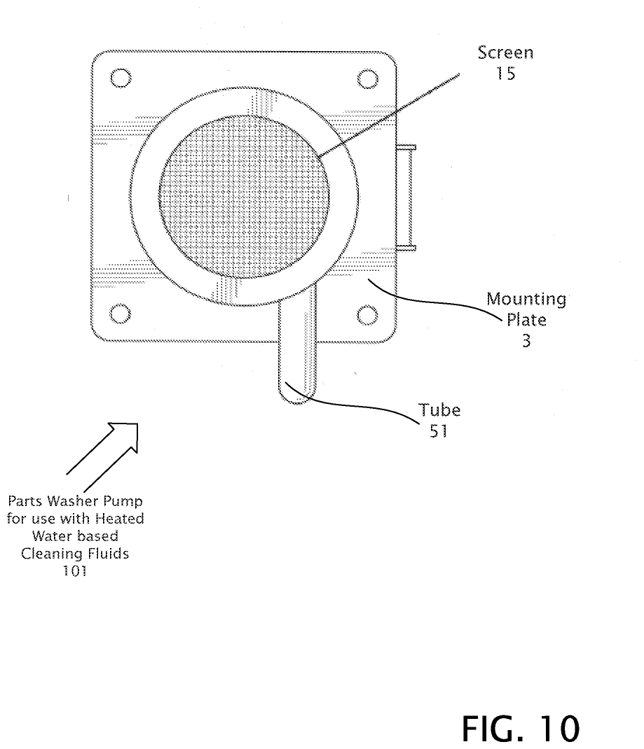

FIG. 10 is a bottom view of a parts washer pump for use with heated water based cleaning fluids.

The motor 2 may be mounted to a universal mounting plate 3 via standoffs 50. The mounting plate may include a cover (19 of FIG. 2) and mounting hardware that allows the pump 101 to be either removably or permanently be mounted to an object such as a drum 16 or a catch basin 22. The motor may be AC or DC and may include thermal overload protection circuitry. In the applications described herein, the motor is typically a fractional horsepower power rating. The motor may be activated by a switch, a foot pedal, or the like. The motor typically provides an axial drive shaft that protrudes from opposite sides of the motor.

A conventionally bladed fan 1 may be coupled to a first end of a motor shaft to promote air cooling of the motor. Air is directed onto the motor 2 and in the example shown the fan 1 turns at the same speed as the motor 2. In alternative examples the fan may include a speed adjustment mechanism, and/or thermostatic control.

A conventionally constructed rubber drive coupling 11 may be disposed between a second end of the motor shaft, and a long drive shaft 8 that extends vertically through the solvent and into the pump 6. The drive coupling 11 couples the motor 2 to the drive shaft 8 and also tends to isolate vibrations that may be present.

The drive shaft 8 couples the motor 2 to the pump 6. A bearing housing 55, with an internal bearing 10 is disposed on the bottom (or alternatively on the top or center) of the mounting plate 3. The bearing engages and supports the motor end of the shaft 8. The pump end of the shaft 8, drives a pump 6, which may be a conventional impeller pump or the like.

A supporting extension tube or equivalently a mounting tube 4 surrounds the shaft 8, and is attached at a first end to the bearing housing, and at the second end to the pump 6. The tube 4 includes a vent aperture to prevent air or hydraulic lock of the pump. The mounting tube may be made of metal, plastic, or any suitable material. The mounting tube serves to maintain the pump and motor in a fixed relationship with each other, and protect the turning shaft that drives the impeller pump.

The pump 6 is a typical impeller pump that may be mounted in a metal, plastic, or equivalent pump housing. The impeller is axially driven by the shaft 8. A pump outlet 51 positioned at the side of the pump, and may be coupled to a hose or the like that supplies the solution to a desired location. A pump inlet tube 52 extends from the bottom of the pump 6.

A pump intake 9 is conventionally constructed to hold a screen 15 (and in alternative examples a filter media), and may be coupled to the pump 6 via a tube 52 aligned axially with the shaft 8, and at the bottom side of the pump.

In summary, a shaft couples the pump to the motor inside a mounting tube that is fixedly attached to the pump and the mounting plate. The mounting tube may include one or more vent holes. The mounting tube may also include one or more internal bearings in which the shaft turns. The shaft may also be coupled to the motor through a rubber (or equivalent) drive coupling.

Those skilled in the art will realize that the process sequences described above may be equivalently performed in any order to achieve a desired result. Also, sub-processes may typically be omitted as desired without taking away from the overall functionality of the processes described above.

1. A parts washer pump comprising:
a fan cooled electric motor mounted on a mounting plate and having a motor shaft;
a coupling coupled to the motor shaft at a first coupling end and a drive shaft at a second coupling end;
a mounting plate including a bearing disposed in a mounting plate bearing housing and through which the driveshaft extends, contacting and being supported by the bearing;
a supporting tube enclosing the drive shaft and attached to the bearing housing;
a submersible impeller pump housing coupled at a second end of the support tube at a second end of the drive shaft, the submersible impeller pump housing including an impeller driven by a second end of the drive shaft.

2. The parts washer pump of claim 1, in which the fan cooled electric motor is one horsepower or less.

3. The apparatus of claim 1, further comprising a pump intake coupled to the pump housing by a tube.

4. The parts washer pump of claim 1, in which the drive shaft is of a length from 24-30 inches.

5. The parts washer pump of claim 1, in which the drive shaft is of an adjustable length.

6. The parts washer pump of claim 1, in which the supporting tube is vented.

7. The parts washer pump of claim 1, in which the output of the impeller pump is a rigid tube exiting a side of the impeller pump.

8. The parts washer pump of claim 1, further comprising a pump intake coupled to the impeller pump housing via a tube.

9. A parts washer pump comprising:
an electric motor with a motor shaft having a first motor shaft end protruding from a top motor surface and a second motor shaft end protruding from a bottom motor surface;
a bladed fan attached to the first motor shaft end;
a coupling coupled having a first coupling end coupled to the second motor shaft end, and a second coupling end;
a driveshaft having a first end and a second end, with the first end coupled to the second coupling end of the coupling;
a mounting plate including a bearing housing with a bearing disposed therein and through which the driveshaft extends, and to which the electric motor is attached;
a supporting tube enclosing the drive shaft and attached to a bearing housing on the mounting plate at a first support tube end;
a submersible impeller pump attached to a second support tube end, and including an impeller driven by the drive shaft; and
a pump intake coupled to the submersible impeller pump via a semi-rigid tube.

10. The parts washer pump of claim 9 in which the bladed fan is a single piece having at least two fan blades, and a hole at a center of balance to couple to a shaft.

11. The parts washer pump of claim 10 in which the bladed fan is plastic and the at least two fan blades are oriented to direct cooling air over the motor.

12. The parts washer pump of claim 10 in which the pump intake includes a screen.

13. A parts washer comprising:
a basin;
a parts washing pump including:
an electric motor with a motor shaft having a first motor shaft end protruding from a top motor surface and a second motor shaft end protruding from a bottom motor surface;
a bladed fan attached to the first motor shaft end;
a coupling coupled having a first coupling end coupled to the second motor shaft end, and a second coupling end;
a driveshaft having a first end and a second end, with the first end coupled to the second coupling end of the coupling;
a mounting plate including a bearing housing with a bearing disposed therein and through which the driveshaft extends, and to which the electric motor is attached;
a supporting tube enclosing the drive shaft and attached to a bearing housing on the mounting plate at a first support tube end;
a submersible impeller pump attached to a second support tube end, and including an impeller driven by the drive shaft and further including a rigid pump output tube; and
a pump intake coupled to the submersible impeller pump via a semi-rigid intake coupling tube;
a flexible take up tube coupled at a first end to the rigid pump output tube;
a spray nozzle with a brush attached to a second end of the flexible take up tube, and fixedly attached to the basin adjacent to the second end of the flexible take up tube for directing a solvent spray.

14. The parts washer of claim 13, in which the basin sits on top of a drum.

15. The parts washer of claim 13, further comprising a foot pedal switch coupled to the motor.

16. The parts washer of claim 13, further comprising a backsplash attached to the basin.

17. The parts washer of claim 13, further comprising a cover covering the motor.

18. The parts washer of claim 13, in which the pump intake includes a cup shaped screen.

19. The parts washer of claim 13, in which the bladed fan is press fit to the first motor shaft end.

20. The parts washer of claim 13, in which the bladed fan is thermostatically controlled.
